(19) United States
(12) Patent Application Publication
(10) Pub. No.: US 2024/0106284 A1
(43) Pub. Date: Mar. 28, 2024

(54) ARMATURE OF LINEAR MOTOR

(71) Applicant: Fanuc Corporation, Minamitsuru-gun, Yamanashi (JP)

(72) Inventor: Yuusuke Kondou, Minamitsuru-gun, Yamanashi (JP)

(73) Assignee: Fanuc Corporation, Minamitsuru-gun, Yamanashi (JP)

(21) Appl. No.: 18/266,854

(22) PCT Filed: Jan. 5, 2022
(86) PCT No.: PCT/JP2022/000145

§ 371 Date: Jun. 13, 2023

(30) Foreign Application Priority Data
Jan. 12, 2021 (JP) 2021-002983

(51) Int. Cl. H02K 1/18

(52) U.S. Cl. CPC H02K 1/18

(57) ABSTRACT

An armature of a linear motor includes a winding wire; a core which is formed by laminating electromagnetic steel sheets and on which the winding wire is wound; and a binding member which is inserted into the core and which binds the core to a prescribed place. The binding member includes a locking part locked to the core, and a binding hole that does not penetrate the binding member and that is exposed from the core.

### CROSS REFERENCE TO RELATED APPLICATIONS

This is the U.S. National Phase application of PCT/JP2022/000145, filed Jan. 5, 2022, which claims priority to Japanese Patent Application No. 2021-002983, filed Jan. 12, 2021, the disclosures of each of these applications being incorporated herein by reference in their entireties for all purposes.

### FIELD OF THE INVENTION

The present invention relates to a linear motor technique, in particular, to an armature of a linear motor.

### BACKGROUND OF THE INVENTION

Generally, an armature of a cored linear motor includes a winding and a core which is formed by laminating electromagnetic steel sheets such as thin silicon steel sheets and has teeth around which the winding is wound. When a screw hole is formed in the core in order to fix such an armature to a predetermined position, a crack is likely to be generated between the thin plates. Therefore, a method is well known in which a binding member having a threaded hole is inserted into the core, and the armature is fixed by sandwiching the core between the binding member and a predetermined portion. (e.g., Patent Literature 1).

As a cross-sectional shape of the binding member, a square, a trapezoidal, and a T-shape, etc., are generally known (e.g., Patent Literatures 1 to 3). FIG. 12 is a perspective view of an armature 80 of a conventional linear motor. The armature 80 includes a winding (not shown), a core 81 around which the winding is wound, and a binding member 82 inserted into the core 81 to bind the core to a predetermined portion. The core 81 is formed by laminating electromagnetic steel plates 81d. The core 81 includes a base part 81a, a plurality of teeth 81b extending from the base part 81a and around which the winding is wound, and an insertion part 81c into which the binding member 82 is inserted. The binding member 82 is made of a magnetic material (soft magnetic material) such as iron, nickel, cobalt, and alloys thereof. The binding member 82 has a T-shape in a cross section XZ orthogonal to the insertion direction Y. Similarly, the insertion part 81c of the binding member 82 has a T-shape following the binding member 82. The T-shaped binding member 82 has an engaging part 82a which engages with the core 81 and a binding hole 82b exposed from the core 81. The engaging part 82a is, for example, a step which protrudes in a direction different from the binding direction Z of the binding member 82. The binding hole 82b is, for example, a threaded hole.

Since the T-shaped binding member 82 has the engaging part 82a, the thickness of the base part 81a of the core 81 tends to increase. FIG. 13 is a cross-sectional view of the armature 80 of FIG. 12 taken along a line XIII-XIII When the binding member 82 is T-shaped, the engaging width A of the engaging part 82a tends to be larger than the tooth width B of the core 81 in the section XZ. Therefore, when the height C of the binding member 82 inside the core 81 is increased in order to secure the depth of the binding hole 82b, it is necessary to increase the thickness D of the base part 81a. As a result, the thickness E of the core 81 as a whole increases, resulting in an increase in the size of the linear motor. Even when the binding member 82 has a trapezoidal shape, the same problem occurs because the binding member 82 has the engaging part 82a.

On the other hand, when the binding member 82 is square, the binding member 82 does not have the engaging part 82a, and thus the thickness E of the core 81 as a whole can be reduced by arranging the binding member 82 in the tooth part 81b of the core 81. FIG. 14 is a perspective view of an armature 90 of a conventional linear motor. By arranging a rectangular binding member 92 in the tooth part 91b, the thickness of the core 91 can be reduced and the size of the linear motor can be reduced. However, since the rectangular binding member 92 does not have an engaging part, the binding member 92 falls off from the core 91 when the binding hole 92b of the binding member 92 is exposed from the core 91. Therefore, it is necessary to form a binding hole 91e in the core 91. However, the formation of the hole not only increases the manufacturing cost, but also causes a crack between magnetic steel plates 91d as described above.

In addition, since water generally tends to enter the linear motor through the gap between the electromagnetic steel plates 91d, attaching a waterproof cover to the exposed surface of the core 91 is often adopted as a waterproofing measure. FIG. 15 is a cross-sectional view of the armature 90 of FIG. 14 taken along a line XV-XV. The armature 90 further has a waterproof cover 93 on the exposed surface of the core 91. However, when the binding hole 91e is formed in the core 91 as described above, an inner wall of the binding hole 91e is exposed as indicated by the dashed elliptical line, and thus water also enters the linear motor through the gap between the electromagnetic steel plates 91d. Also, it is difficult to attach a waterproof cover to the inner wall of the binding hole 91e. Furthermore, since the binding hole 92b of the binding member 92 penetrates through the binding member 92, the insertion part 91c of the binding member 92 is also exposed as indicated by the elliptical dashed line, whereby water also enters the linear motor through the gap between the electromagnet steel plates.

### PATENT LITERATURE

[PTL 1] JP 1997(H09)-070166 A
[PTL 2] JP 2000-217334 A
[PTL 3] JP 2005-287113 A

### SUMMARY OF THE INVENTION

In view of the problems in the prior art, an object of the present invention is to provide a compact and waterproof armature for a linear motor.

One aspect of the present disclosure is an armature of a linear motor, comprising: a winding; a core formed by laminating electromagnetic steel plates, around which the winding is wound; and a binding member configured to be inserted into the core to bind the core to a prescribed portion, wherein the binding member includes an engaging part configured to engage with the core, and a binding hole which is exposed from the core and does not penetrate the binding member.

Another aspect of the present disclosure is an armature of a linear motor, comprising: a winding; a core formed by laminating electromagnetic steel plates, around which the winding is wound; and a binding member configured to be inserted into the core to bind the core to a prescribed portion, wherein the binding member includes an engaging part configured to engage with the core, and a binding rod extending toward outside the core.

According to the aspect of the present disclosure, a compact armature having a waterproof characteristic can be provided for a linear motor.

### BRIEF DESCRIPTION OF DRAWINGS

FIG. 1 is a perspective view of an armature of a linear motor according to a first embodiment.

FIG. 2 is a cross-sectional view of the armature of FIG. 1 along a II-II line.

FIG. 3 is a perspective view of an armature of a linear motor according to a second embodiment.

FIG. 4 is a cross-sectional view of the armature of FIG. 3 along a IV-IV line.

FIG. 5 is a perspective view of an armature of a linear motor according to a third embodiment.

FIG. 6 is a cross-sectional view of the armature of FIG. 5 along a VI-VI line.

FIG. 7 is a cross-sectional view showing a modification of a binding member of FIG. 5.

FIG. 8 is a perspective view of an armature of a linear motor according to a fourth embodiment.

FIG. 9 is a cross-sectional view of the armature of FIG. 8 along a IX-IX line.

FIG. 10 is a perspective view of an armature of a linear motor according to a fifth embodiment.

FIG. 11 is a cross-sectional view of the armature of FIG. 10 along a XI-XI line.

FIG. 12 is a perspective view of an armature of a conventional linear motor.

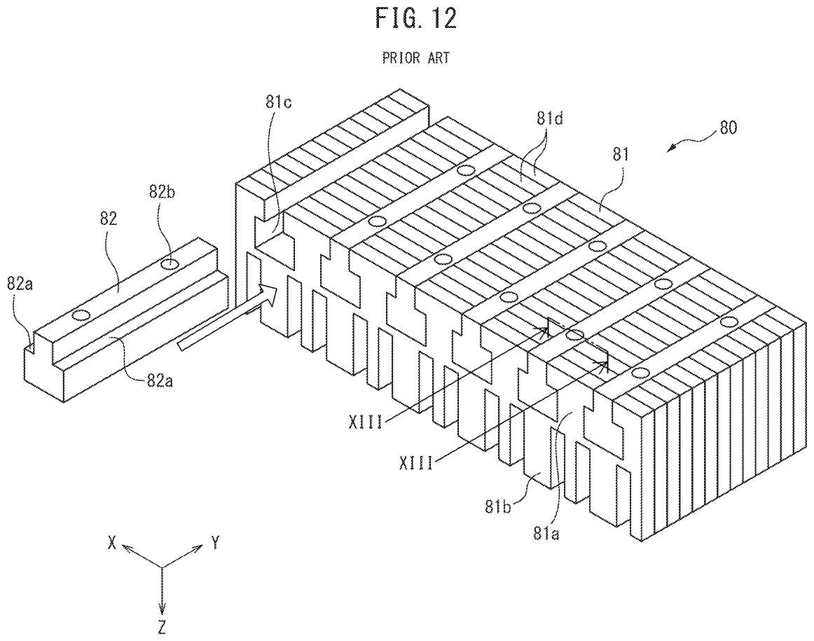

FIG. 13 is a cross-sectional view of the armature of FIG. 12 along a XIII-XIII line.

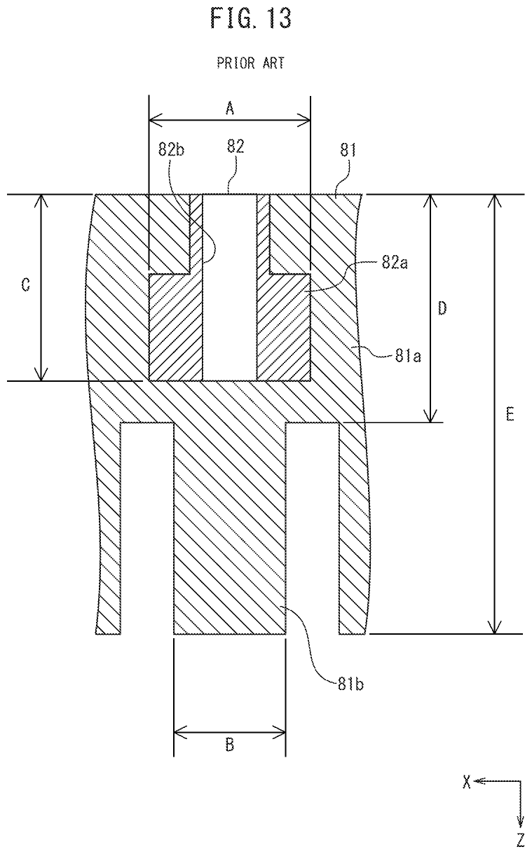

FIG. 14 is a perspective view of an armature of a conventional linear motor.

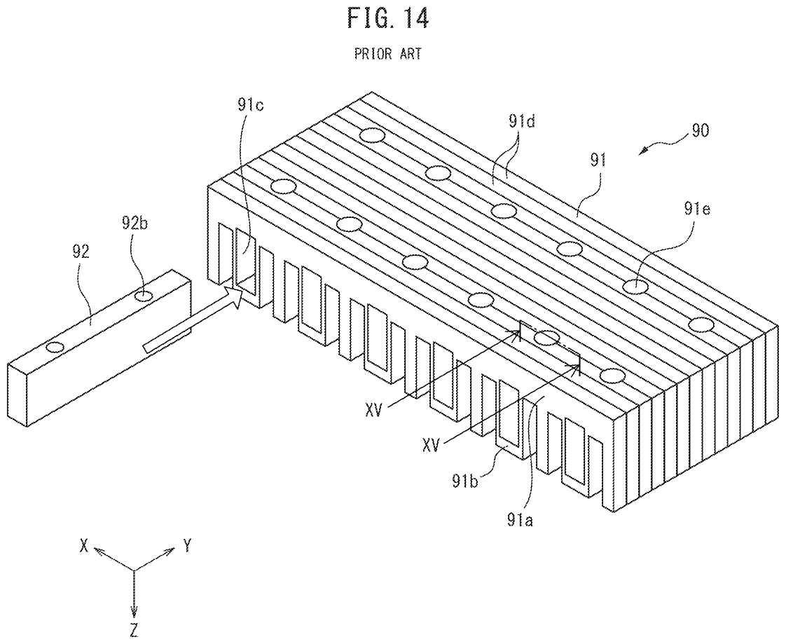

FIG. 15 is a cross-sectional view of the armature of FIG. 14 along a XV-XV line.

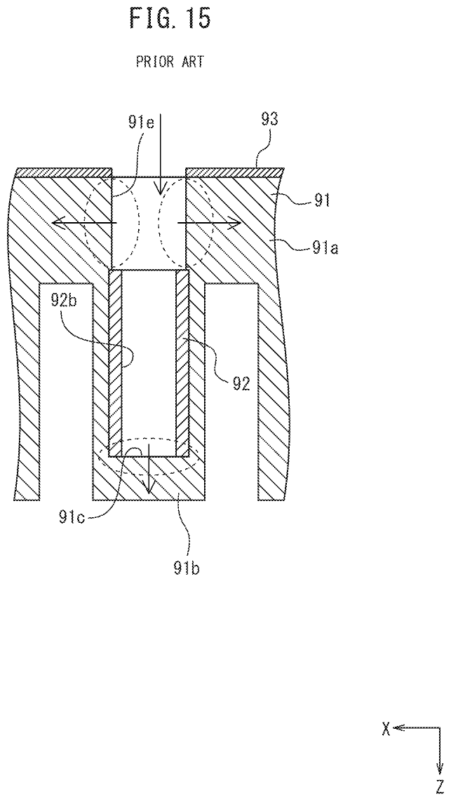

### DETAILED DESCRIPTION OF EMBODIMENTS OF THE INVENTION

Below, embodiments of the present disclosure will be explained in detail while referring to the attached drawings. In each drawing, the same or similar components are assigned the same or similar reference numerals. Further, the embodiments described below do not limit the technical scope of the invention and the significance of the terms described in the claims.

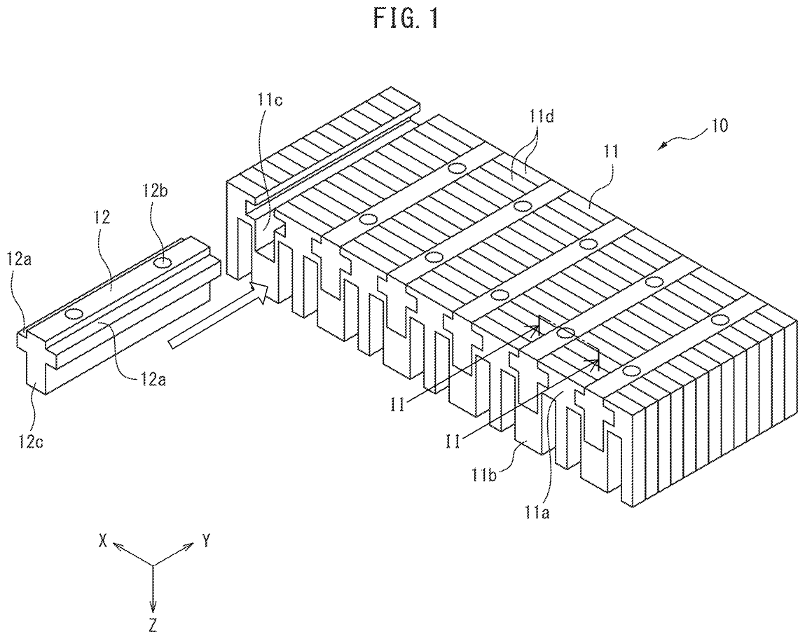

FIG. 1 is a perspective view of an armature 10 of a linear motor according to a first embodiment. The armature 10 has a winding not shown, a core 11 around which the winding is wound, and a binding member 12 configured to be inserted into the core 11 to bind the core 11 to a prescribed portion. The core 11 is formed by laminating electromagnetic steel plates 11d. The core 11 has a base part 11a, a tooth part 11b extending from the base part 11a, around which the winding is wound, and an insertion part 11c into which the binding member 12 is inserted. For example, the binding member 12 is made of a magnetic material (soft magnetic material) such as iron, nickel, cobalt, and alloys thereof. For example, the binding member 12 has a cross-shape in a cross section XZ orthogonal to the insertion direction Y. Similarly, the insertion part 11c of the binding member 12 has a cross-shape following the binding member 12. The cross-shaped binding member 12 has an engaging part 12a which engages with the core 11 and a binding hole 12b which is exposed from the core 11 and does not penetrate the binding member 12. The engaging part 12a is, for example, a step which protrudes in a direction different from the binding direction Z of the binding member 12. In this regard, the “direction different from . . . ” may mean, for example, the direction orthogonal to the binding direction Z, but may mean the inclined direction relative to the binding direction Z. The binding hole 12b may be, for example, a screw hole which is threaded so as not to penetrate the binding member 12. However, when other binding methods such as snap-fit binding, press-fit binding, adhesive binding, etc., are employed instead of screw binding, an unthreaded binding hole may also be used.

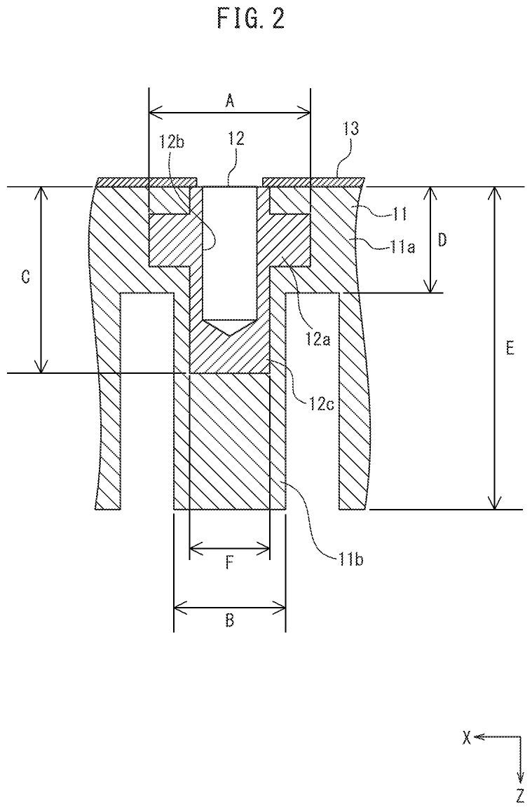

The cross-shaped binding member 12 further has a tooth-side end part 12c extending closer to the tooth side of the core 11 than the engaging part 12a. In order to reduce the thickness of the core 11, the tooth-side end part 12c preferably extends into the tooth part 11b of the core 11. FIG. 2 is a II-II sectional view of the armature 10 of FIG. 1. In the cross section XZ, an engaging width A of the engaging part 12a is larger than a tooth width B of the core 11. In this regard, by making a width F of the tooth-side end part 12c of the biding member 12 smaller than the tooth width B of the core 11, the tooth-side end part 12c can extend into the tooth part 11b of the core 11. Therefore, even when the height C of the binding member 12 within the core 11 is increased in order to secure the depth of the binding hole 12b, it is not necessary to increase the thickness D of the base part 11a of the core 11. Accordingly, the thickness E of the core 11 as a whole can be reduced, and the linear motor can be made smaller (thinner).

When the binding member 12 is cross-shaped, by extending the binding hole 12b of the binding member 12 to the exposed surface of the core 11, it is not necessary to form the binding hole in the core 11. Therefore, the manufacturing cost due to hole formation can be reduced and formation of a crack between the electromagnetic steel plates 11d can be prevented. Further, by extending the binding hole 12b of the binding member 12 to the exposed surface of the core 11 and not penetrating the binding member 12, there is no exposed portion in the core 11, whereby the core 11 has a structure which is resistant to water intrusion through the gap between the electromagnetic steel plates 11d. Therefore, simply by providing the waterproof cover 13 on the exposed surface of the core 11 as in the prior art, it is possible to provide the armature 10 which is both small (thin) and waterproof.

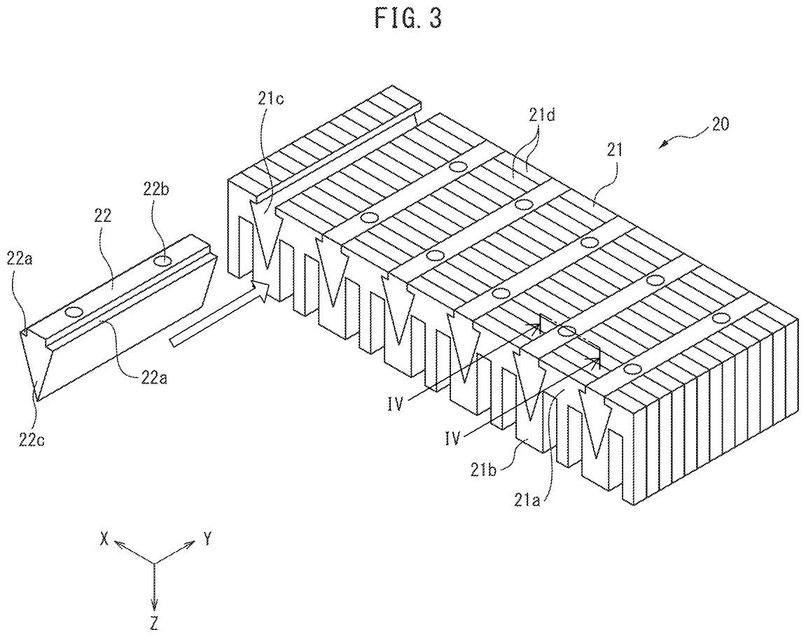

FIG. 3 is a perspective view of an armature 20 of a linear motor according to a second embodiment. Note that only components different from the armature 10 of the first embodiment will be described below, and descriptions of the same components will be omitted. In the armature 20 of the second embodiment, a binding member 22 has an arrow shape in the cross section XZ perpendicular to the insertion direction Y, for example. Similarly, an insertion part 21c of the binding member 22 also has an arrow shape following the binding member 22.

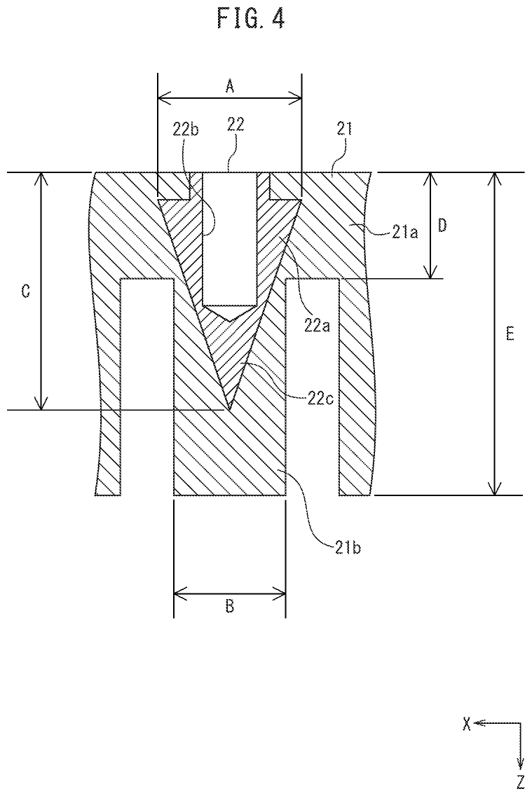

When the binding member 22 is arrow-shaped, the tooth-side end part 22c has a tapered shape in which the width narrows toward the tooth part 21b of the core 21. FIG. 4 is a IV-IV cross-sectional view of the armature 20 of FIG. 3. In the cross section XZ, the engaging width A of the engaging part 22a is larger than the tooth width B of the core 21. In this regard, by making the width of the tooth-side end part 22c of the binding member 22 narrower than the tooth width B of the core 21, the tooth-side end part 22c can extend into the tooth part 21b of the core 21, the thickness E of the core 21 as a whole can be reduced, and the linear motor can be made smaller (thinner). Further, by forming the binding member 22 in the arrow shape, a sufficient area for the core 21 can be secured to suppress the influence of iron loss (eddy current loss) due to the binding member 22.

When the binding member 22 is arrow-shaped, by extending the binding hole 22b of the binding member 22 to the exposed surface of the core 21, it is not necessary to form the binding hole in the core 21. Therefore, the manufacturing cost due to hole formation can be reduced and formation of a crack between the electromagnetic steel plates 21d can be prevented. Further, by extending the binding hole 22b of the binding member 22 to the exposed surface of the core 21 and not penetrating the binding member 22, there is no exposed portion in the core 21, with the result that the core 21 has a structure which is resistant to water intrusion through the gap between the electromagnetic steel plates 21d. Therefore, it is possible to provide an armature 20 which is both small (thin) and waterproof.

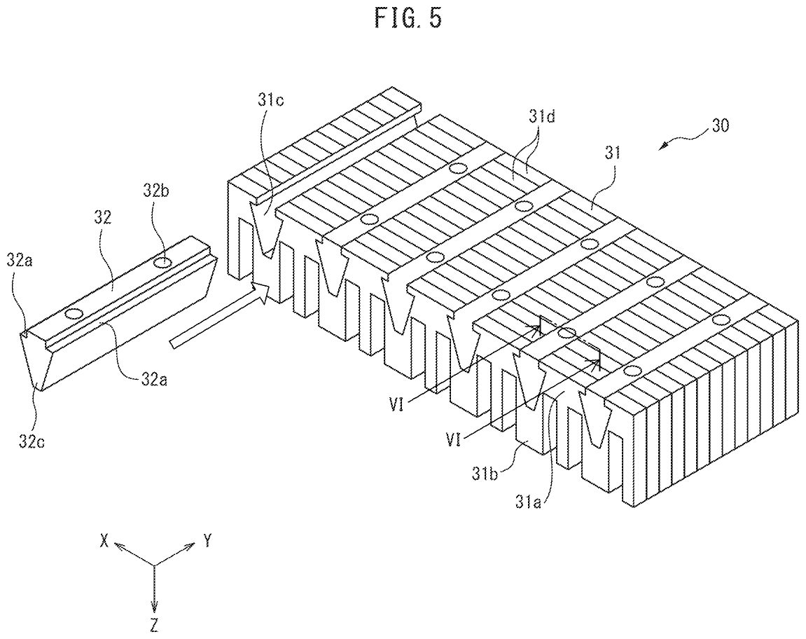

FIG. 5 is a perspective view of an armature 30 of a linear motor according to a third embodiment. Note that only components different from the armature 20 of the second embodiment will be described below, and descriptions of the same components will be omitted. In the armature 30 of the third embodiment, a binding member 32 has an arrow shape in the cross section XZ perpendicular to the insertion direction Y, for example, and a front end of a tooth-side end part 32c is a flat surface. Similarly, an insertion part 31c of the binding member 32 also has an arrow shape following the front end of the tooth-side end part 32c.

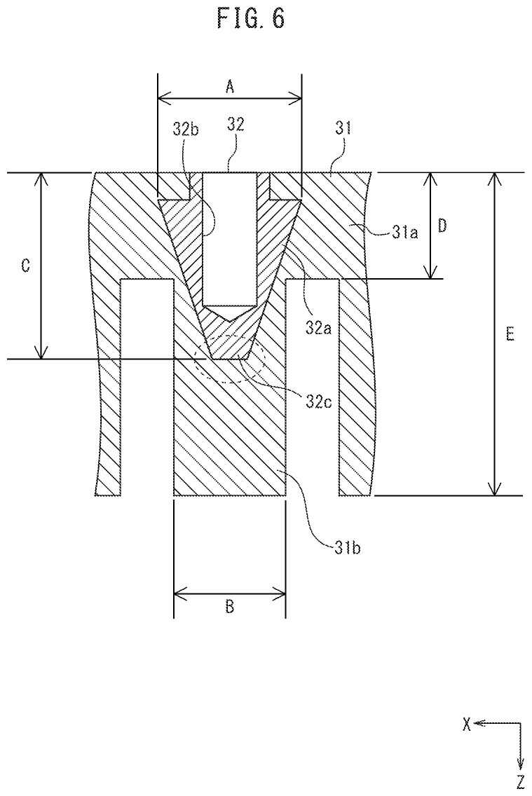

FIG. 6 is a VI-VI cross-sectional view of the armature 30 of FIG. 5. By making the front end of the arrow-shaped binding member 32 flat as indicated by the elliptical dashed line, even when the binding member 32 is formed by extrusion molding, etc., the front end of the tooth-side end part 32c can be prevented from being chipped. Therefore, it is possible to increase the yield ratio of the binding member 32 and improve the production efficiency of the linear motor. Further, by making the front end of the arrow-shaped binding member 32 flat, it is possible to secure a larger area for the core 31 than when a sharp arrow-shaped binding member is used, so that the influence of iron loss (eddy current loss) due to the binding member 32 can be suppressed.

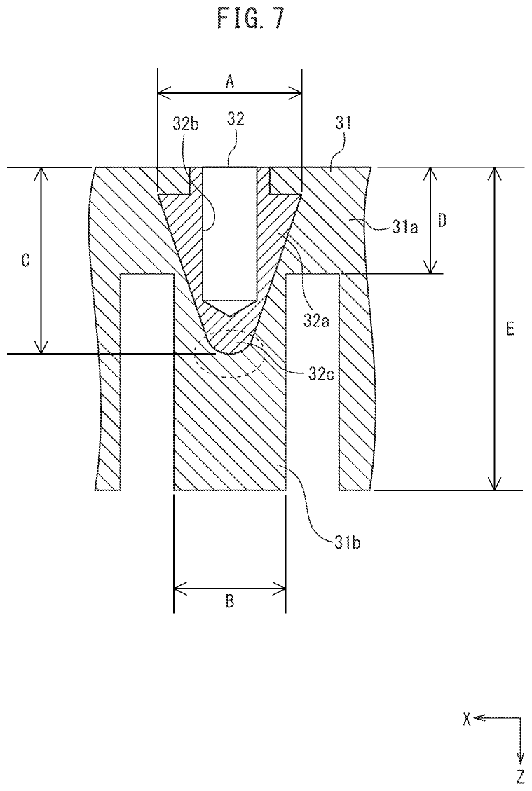

As an alternative embodiment, the front end of the arrow-shaped binding member 32 may be formed as a curved surface. FIG. 7 is a cross-sectional view showing a modification of the binding member 32 of FIG. 5. The front end of the tooth-side end part 32c is a curved surface. Similarly, the insertion part 31c of the binding member 32 (see FIG. 5) also has a curved surface following the front end of the tooth-side end part 32c. By making the front end of the arrow-shaped binding member 32 the curved surface, the tooth-side end part 32c has no corners, with the result that chipping of the front end of the tooth-side end part 32c during extrusion molding of the binding member 32 can be further prevented. Therefore, it is possible to increase the yield ratio of the binding member 32 and improve the production efficiency of the linear motor.

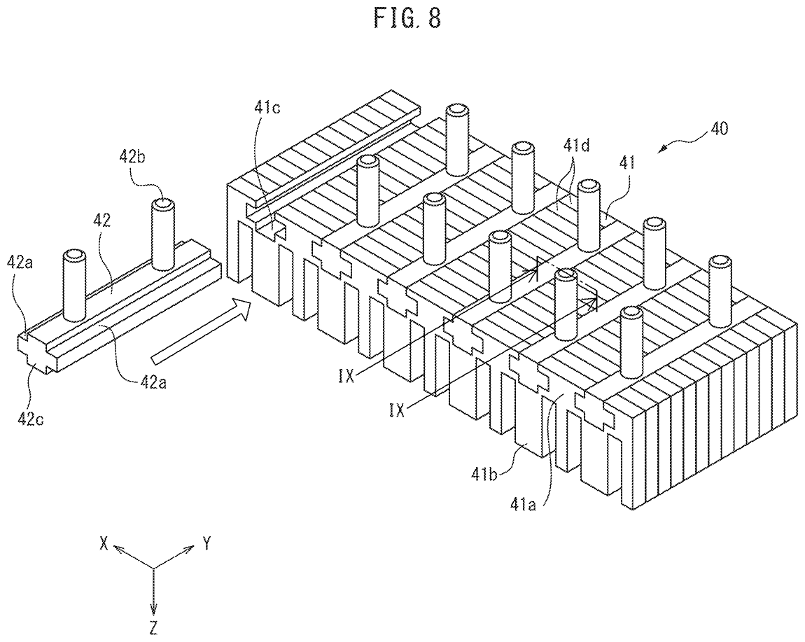

FIG. 8 is a perspective view of an armature 40 of a linear motor according to a fourth embodiment. Note that only components different from the armature 10 of the first embodiment will be described below, and descriptions of the same components will be omitted. In the armature 40 of the fourth embodiment, a binding member 42 has a binding rod 42b extending outside a core 41 instead of a binding hole. The binding rod 42b is, for example, a threaded screw rod. However, when the other joining methods such as snap-fitting, press-fitting, adhesive bonding, etc., are used instead of threaded binding, the binding rod 42b may be an unthreaded binding rod.

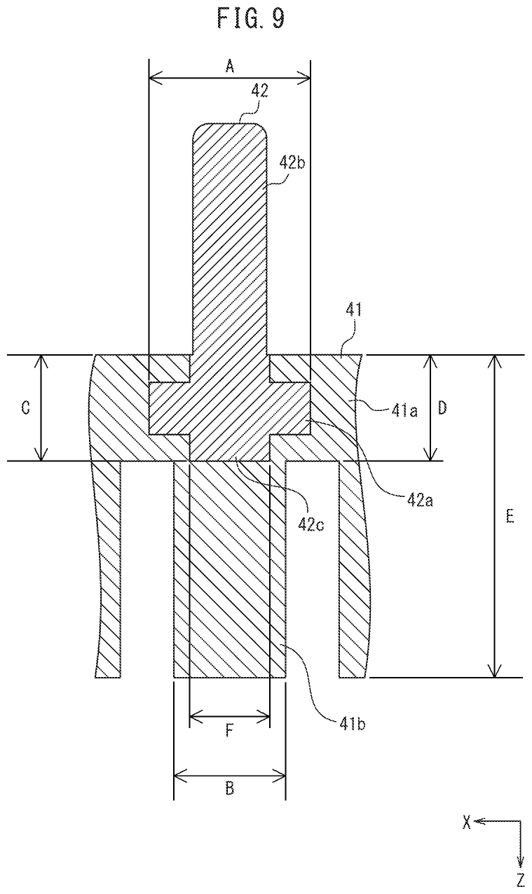

Since the binding member 42 does not have a binding hole, it is not necessary to increase the height of the binding member 42 in the core 41 in order to secure the depth of the binding hole. FIG. 9 is a IX-IX cross-sectional view of the armature 40 of FIG. 8. In the cross section XZ, the engaging width A of the engaging part 42a of the binding member 42 is larger than the tooth width B of the core 41. In this regard, since it is not necessary to secure the depth of the binding hole, the height C of the binding member 42 in the core 41 can be made equal to or less than the thickness D of the base part 41a. By virtue of this, the thickness E of the core 41 as a whole can be reduced, and the linear motor can be made smaller (thinner).

Since it is not necessary to form a binding hole in the core 41, the manufacturing cost due to hole formation can be reduced, and formation of a crack between the electromagnetic steel plates 41d can be prevented. Further, since the binding member 42 has the binding rod 42b, there is no exposed part in the core 41, with the result that the core 41 has a structure which is resistant to water intrusion through the gap between the electromagnetic steel plates 11d. Therefore, it is possible to provide the armature 40 which is both small (thin) and waterproof. In addition, the binding member 42 having the binding rod 42b may be arrow-shaped or T-shaped instead of cross-shaped. It should be noted that, when the binding member 42 is T-shaped, it does not have the tooth-side end part 42c.

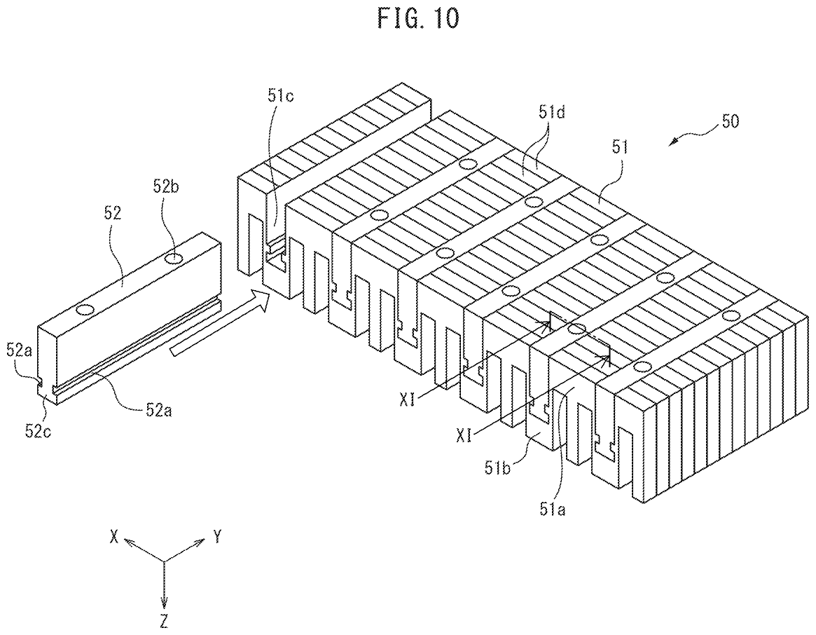

FIG. 10 is a perspective view of an armature 50 of a linear motor according to a fifth embodiment. Note that only components different from the armature 10 of the first embodiment will be described below, and descriptions of the same components will be omitted. In the armature 50 of the fifth embodiment, a binding member 52 has a syringe shape in the cross section XZ perpendicular to the insertion direction Y, for example. In other words, in the cross section XZ, the binding member 52 has a shape corresponding to a combination of a cylinder-like quadrangle and a piston-like T-shape. Similarly, an insertion part 51c of the binding member 52 also has a syringe shape following the binding member 52.

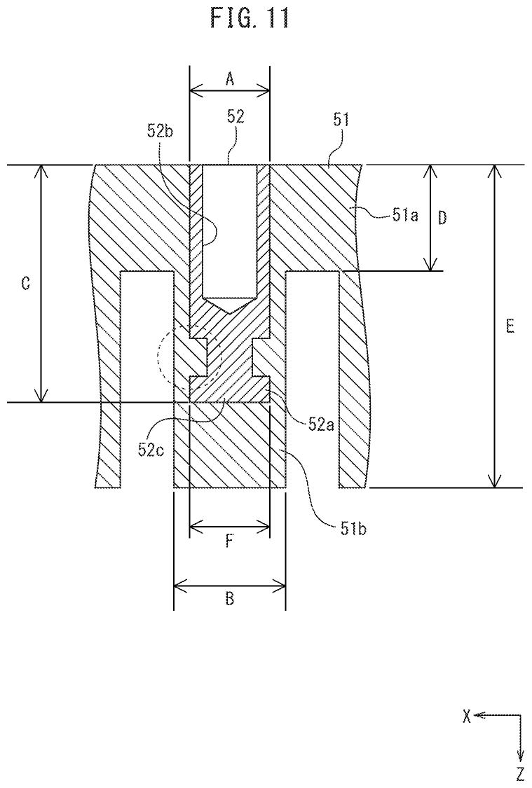

When the binding member 52 has the syringe shape, the engaging width of the engaging part 52a can be made smaller than the tooth width of the core 51. FIG. 11 is a XI-XI cross-sectional view of the armature 50 of FIG. 10. In the cross section XZ, the engaging width B of the engaging part 52a is smaller than the tooth width B of the core 51, so that the engaging part 52a can be positioned within the tooth part 51b. Therefore, even when the height C of the binding member 52 in the core 51 is increased in order to secure the depth of the binding hole 52b, the thickness D of the base part 51a can be reduced. Accordingly, the thickness E of the core 51 as a whole can be reduced, and the linear motor can be made smaller (thinner).

Since it is not necessary to form a binding hole in the core 51, the manufacturing cost due to hole formation can be reduced, and formation of a crack between the electromagnetic steel plates 41d can be prevented. Further, by extending the binding hole 52b of the binding member 52 to the exposed surface of the core 51 and not penetrating the binding member 52, there is no exposed portion in the core 51, so that the core 51 has a structure which is resistant to water intrusion through the gap between the electromagnetic steel plates 51d. Therefore, it is possible to provide the armature 50 which is both small (thin) and waterproof.

According to the above embodiments, it is possible to provide the armatures 10 to 50 which are compact (thin) and waterproof for the linear motors. It should be noted that the armatures in the above embodiments are applicable not only to linear motor armatures, but also to rotary motor armatures.

Although various embodiments have been described herein, it should be recognized that the present invention is not limited to the embodiments described above, and that various modifications can be made within the scope of the claims.

### REFERENCE SIGNS LIST

10, 20, 30, 40, 50, 80, 90 armature
11,21, 31, 41, 51, 81, 91 core
11a, 21a, 31a, 41a, 51a, 81a, 91a base part
11b, 21b, 31b, 41b, 51b, 81b, 91b tooth part
11c, 21c, 31c, 41c, 51c, 81c, 91c insertion part
11d, 21d, 31d, 41d, 51d, 81d, 91d electromagnet steel plate
12, 22, 32, 42, 52, 82, 92 binding member
12a, 22a, 32a, 42a, 52a, 82a engaging part
12b, 22b, 32b, 52b, 91e binding hole
82b, 92b binding hole
42b binding rod
12c, 22c, 32c, 42c, 52c tooth-side end part
13, 93 waterproof cover

1. An armature of a linear motor, comprising:
a winding;
a core formed by laminating electromagnetic steel plates, around which the winding is wound; and
a binding member configured to be inserted into the core to bind the core to a prescribed portion,
wherein the binding member includes an engaging part configured to engage with the core, and a binding hole which is exposed from the core and does not penetrate the binding member.

2. The armature of the linear motor according to claim 1, wherein a cross-section of the binding member has a cross-shape, an arrow-shape or a syringe-shape.

3. The armature of the linear motor according to claim 1, wherein an engaging width of the engaging part is larger or smaller than a tooth width of the core.

4. The armature of the linear motor according to claim 1, wherein the binding member has a tooth-side end part extending into a tooth part of the core.

5. The armature of the linear motor according to claim 4, wherein a width of the tooth-side end part is smaller than a tooth width of the core.

6. The armature of the linear motor according to claim 4, wherein a front end of the tooth-side end part is a flat surface or a curved surface.

7. An armature of a linear motor, comprising:
a winding;
a core formed by laminating electromagnetic steel plates, around which the winding is wound; and
a binding member configured to be inserted into the core to bind the core to a prescribed portion,
wherein the binding member includes an engaging part configured to engage with the core, and a binding rod extending toward outside the core.
